(19) United States
(12) Patent Application Publication
(10) Pub. No.: US 2018/0273034 A1
(43) Pub. Date: Sep. 27, 2018

(54) ADVANCED DRIVER ASSISTANCE SYSTEM

(71) Applicant: DENSO International America, Inc., Southfield, MI (US)

(72) Inventors: Matthew GESCH, Livonia, MI (US); Jin KURUMISAWA, Novi, MI (US); Takayuki KIMURA, Farmington Hills, MI (US)

(21) Appl. No.: 15/468,485

(22) Filed: Mar. 24, 2017

(51) Int. Cl. B60W 30/14; B60W 50/14

(52) U.S. Cl. CPC B60W 30/146; B60W 50/14; B60W 2050/143; B60W 2050/146; B60W 2300/14; B60W 2550/22; B60W 2550/406; B60W 2720/10; B60W 2750/40; B60W 2520/10

(57) ABSTRACT

The present disclosure provides an advanced driver assistance system that includes a trailer detecting unit detecting whether a trailer is connected with a vehicle, a trailer type detecting unit detecting a type of the trailer, and a driving area recognition unit recognizing a driving area where the vehicle is driving. The trailer type detecting unit outputs a trailer type signal. The driving area recognition unit outputs a driving area signal. The system further includes a speed limit recognition unit recognizing a regulated speed limit in the driving area based on the signals, and a speed comparison unit comparing an actual speed of the vehicle with the speed limit. The speed comparison unit outputs an alert signal when the actual speed is over the speed limit. The system further includes an alert unit alerting a driver to reduce the actual speed based on the alert signal.

### FIELD

The present disclosure relates to an advanced driver assistance system for a vehicle.

### BACKGROUND

This section provides background information related to the present disclosure which is not necessarily prior art.

An advanced driver assistance system has been used in a vehicle to help a driver in driving process. Generally, a conventional advanced driver assistance system may provide adaptive cruise control, automate braking, and so forth.

One of the conventional advanced driver assistance systems may be used in a vehicle which is connected with a trailer. A speed limit for the vehicle towing the trailer may be regulated based on a type of the trailer and a driving area, where the vehicle is driving. When the vehicle towing the trailer is automated to drive at a maximum control speed, it may be hard for the conventional advanced driver assistance system to provide lawful control for the vehicle.

### SUMMARY

This section provides a general summary of the disclosure, and is not a comprehensive disclosure of its full scope or all of its features.

An aspect of the present disclosure provides an advanced driver assistance system that includes a trailer detecting unit detecting whether a trailer is connected with a vehicle, and a trailer type detecting unit detecting the type of the trailer when the trailer detecting unit detects that the trailer is connected with the vehicle. The trailer type detecting unit outputs a trailer type signal. The advanced driver assistance system further includes a driving area recognition unit recognizing a driving area where the vehicle is driving when the trailer detecting unit detects that the trailer is connected with the vehicle. The driving area recognition unit outputs a driving area signal. The advanced driver assistance system further includes a speed limit recognition unit recognizing a regulated speed limit in the driving area based on the trailer type signal and the driving area signal, and a speed comparison unit comparing an actual speed of the vehicle with the speed limit. The speed comparison unit outputs an alert signal when the actual speed is over the speed limit. The advanced driver assistance system further includes an alert unit alerting a driver, who is driving the vehicle, to reduce the actual speed based on the alert signal.

Another aspect of the present disclosure provides an advanced driver assistance system that includes a trailer detecting unit detecting whether a trailer is connected with a vehicle, and a trailer type detecting unit detecting the type of the trailer when the trailer detecting unit detects that the trailer is connected with the vehicle. The trailer type detecting unit outputs a trailer type signal. The advanced driver assistance system further includes a driving area recognition unit recognizing a driving area where the vehicle is driving when the trailer detecting unit detects that the trailer is connected with the vehicle. The driving area recognition unit outputs a driving area signal. The advanced driver assistance system further includes a speed limit recognition unit recognizing a regulated speed limit in the driving area based on both of the trailer type signal and the driving area signal, and a control speed determination unit determining a parameter of a control speed to have the vehicle driving at the control speed automatically based on the parameter of the control speed. The advanced driver assistance system further includes a speed limit control unit restricting the parameter of the control speed so that the control speed, which is determined by the control speed determination unit, is not over the speed limit, which is recognized by the speed limit recognition unit.

Further areas of applicability will become apparent from the description provided herein. The description and specific examples in this summary are intended for purposes of illustration only and are not intended to limit the scope of the present disclosure.

### DRAWINGS

The above and other objects, features and advantages of the present invention will become more apparent from the following detailed description made with reference to the accompanying drawings. The drawings described herein are for illustrative purposes only of selected embodiments and not all possible implementations, and are not intended to limit the scope of the present disclosure.

FIG. 1 is a plane view schematically illustrating a vehicle and a trailer according to the first embodiment;

FIG. 2 is a block diagram illustrating an advanced driver assistance system according to the first embodiment;

FIG. 3 is a flowchart executed by the advanced driver assistance system according to the first embodiment; and

FIG. 4 is a graph showing a control speed relative to time according to the first embodiment.

### DETAILED DESCRIPTION

A plurality of embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts may be combined. The embodiments may be partially combined even if it is not explicitly described that the embodiments may be combined, provided there is no harm in the combination.

### First Embodiment

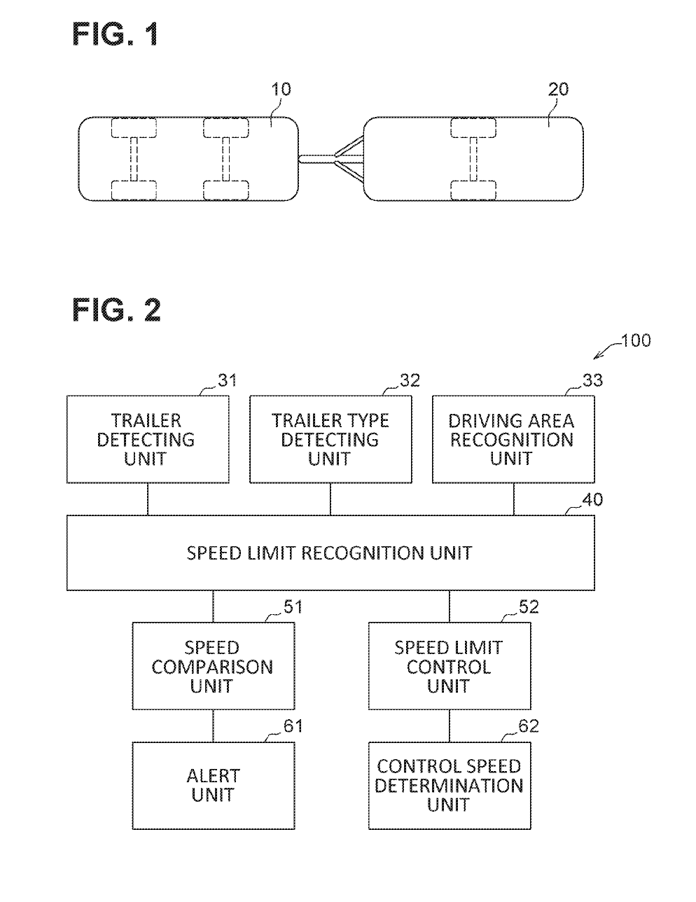

Configuration of an advanced driver assistance system 100 according to the first embodiment will be described. FIG. 1 depicts a plane view schematically illustrating a vehicle 10 and a trailer 20 according to the present embodiment. FIG. 1 shows the vehicle 10 that tows the trailer 20 on a rear side of the vehicle 10.

The advanced driver assistance system 100 is equipped in the vehicle 10. The vehicle 10 is connected with the trailer 20. In other words, the advanced driver assistance system 100 is installed in the vehicle 10, which tows a trailer 20.

The vehicle 10 is a vehicle capable of towing, such as a tractor trailer, a passenger vehicle, and so forth. The vehicle 10 has an attachment, which is not described in FIG. 1, for connection with the trailer 20. In general, the attachment is disposed at a rear of the vehicle 10.

The trailer 20 is connected to the vehicle 10 such that the trailer 20 is capable to pivot on the attachment of the vehicle 10. The trailer 20 has a trailer type, such as a boat-type, a car-type, a house-type, and so forth. In this example, the trailer 20 is a car-type trailer described in FIG. 1. The vehicle 10 is capable to tow a boat-type trailer and house-type trailer as well as the car-type trailer. In other words, the vehicle 10 has the attachment, which is capable to connect with all types of the trailer 20.

Weight of the trailer 20 strongly depends on the trailer type thereof. Thereby, a regulated speed limit for the vehicle 10 towing the trailer 20 depends on the trailer type of the trailer 20. In general, a house-type trailer is usually heavier than a boat-type trailer. In that case, a vehicle towing the house-type trailer is regulated by a lower speed limit than a vehicle towing the boat-type trailer.

FIG. 2 depicts a block diagram illustrating an advanced driver assistance system 100 according to the present embodiment. FIG. 2 shows the advanced driver assistance system 100 that includes a trailer detecting unit 31, a trailer type detecting unit 32, a driving area recognition unit 33, a speed limit recognition unit 40, a speed comparison unit 51, a speed limit control unit 52, an alert unit 61, and a control speed determination unit 62. The advanced driver assistance system 100 provides a driver with help in driving process.

The trailer detecting unit 31 is configured to detect whether the vehicle 10 is connected with the trailer 20. The trailer detecting unit 31 has a detecting device, for example, an ultrasonic sensor, a radar sensor, a LIDAR sensor, a laser sensor, a rear view camera, a touch sensor, and so forth. In this example, the trailer detecting unit 31 is a rear view camera. When the trailer detecting unit 31 detects that the vehicle 10 is connected with the trailer 20, the trailer detecting unit 31 outputs a trailer signal to the trailer type detecting unit 32 and the driving area recognition unit 33.

The trailer type detecting unit 32 is configured to detect the type of the trailer 20, which is connected to the vehicle 10. The trailer type detecting unit 32 has a detecting device, for example, a rear view camera, an ultrasonic sensor, a radar sensor, a LIDAR sensor, a laser sensor. In this example, the trailer type detecting unit 32 is the rear view camera, which is included in the trailer detecting unit 31. In other words, the trailer detecting unit 31 and the trailer type detecting unit 32 use the same rear view camera. The trailer type detecting unit 32 outputs a trailer type signal based on the trailer type of the trailer 20, to the speed limit recognition unit 40.

In the United States of America, the speed limit depends on the trailer type. For example, a state regulates a speed limit of a vehicle towing a house-type trailer at a certain speed. On the other hand, the state regulates a speed limit of a vehicle towing a boat-type trailer at a different speed from the certain speed.

The driving area recognition unit 33 is configured to recognize a driving area where the vehicle is driving. In this example, the driving area recognition unit 33 uses GPS data and map data. In other words, the driving area recognition unit 33 recognizes the driving area via information of the GPS data and the map data. The driving area recognition unit 33 recognizes the driving area, for example, a state, a country, and so forth. The regulated speed limit for the vehicle 10 towing the trailer 20 depends on the driving area. In the United States of America, the speed limit depends on the states. For example, one state regulates a speed limit of a vehicle towing a house-type trailer at a certain speed. On the other hand, another state regulates the speed limit of such a vehicle at a different speed from the certain speed.

It should be noted that the speed limit of the vehicle 10 towing the trailer 20 depends on both of the trailer type and the driving area. In other words, the speed limit is determined based on combination of the trailer type and the driving area.

The speed limit recognition unit 40 is configured to recognize such a speed limit, which depends on the trailer type and the driving area. The speed limit recognition unit 40 inputs the trailer type signal and the driving area signal such that the speed limit recognition unit 40 recognizes the speed limit for the towing vehicle 10 based on the trailer type and the driving area. The speed limit recognition unit 40 outputs a speed limit signal to the speed comparison unit 51 and the speed limit control unit 52.

The speed comparison unit 51 is configured to compare an actual speed, at which the vehicle 10 is driving, with the speed limit. The actual speed is detected by a speed sensor, which is not described in FIG. 2. As the result of the comparison, the speed comparison unit 51 outputs an alert signal to the alert unit 61 when the actual speed is over the speed limit. In the other hand, when the actual speed is not over the speed limit, the speed comparison unit 51 outputs no signals.

The alert unit 61 is configured to alert the driver, who is driving the vehicle 10, to reduce the actual speed. The alert unit 61 follows the alert signal which is outputted from the speed comparison unit 51. The alert unit 61 alerts the driver via an alert device, for example, a human machine interface. The human machine interface has an alert device such as a display to show the alert, and an audio to ring or announce the alert. Eventually, the driver may reduce the actual speed so that the actual speed is not over the speed limit.

The speed limit control unit 52 is configured to restrict a parameter of a control speed so that the control speed is not over the speed limit which is recognized by the speed limit recognition unit 40. When the vehicle 10 is automated to drive, the vehicle is configured to drive at the control speed based on the parameter of the control speed which determined by the control speed determination unit 62. The speed limit control unit 52 outputs a restriction signal to the control speed determination unit 62.

The control speed determination unit 62 is configured to determine the parameter of the control speed. In this example, the control speed determination unit 62 is used for adaptive cruise control. When the restriction signal is inputted to the control speed determination unit 62, the control speed, which is determined by the control speed determination unit 62, is restricted by the speed limit control unit 52. In this example, the control speed determination unit 62 determines the parameter of the control speed to drive the vehicle 10 at the speed limit which is recognized by the speed limit recognition unit 40.

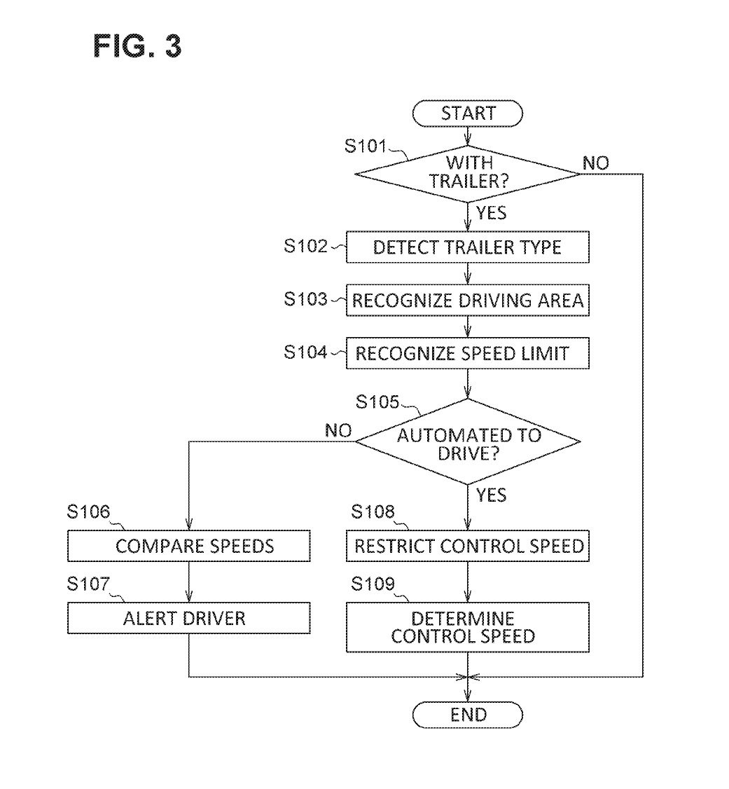

FIG. 3 depicts a flowchart executed by the advanced driver assistance system 100 according to the present embodiment. FIG. 3 shows process of the advanced driver assistance system 100 that has Steps 101˜109 between Start and End. The process starts proceeding accordingly, for example, when the vehicle starts to drive, when the vehicle passes through the border and the boundary between two states, and so forth.

At first, the process proceeds from Start to Step 101 at which the trailer detecting unit 31 detects whether the vehicle 10 is connected with the trailer 20. When the trailer detecting unit 31 detects that the vehicle 10 is connected with no trailer, the process proceeds to End. On the other hands, when the trailer detecting unit 31 detects that the vehicle 10 is connected with the trailer 20, the process proceeds to Step 102.

At Step 102, the trailer type detecting unit 32 detects the type of the trailer 20, which is connected to the vehicle 10. In this example, the trailer type detecting unit 32 detects whether the type of the trailer is a boat-type, a house-type, or a car-type. At the same time of Step 102, Step 103 is executed by the driving area recognition unit 33. At Step 103, the driving area recognition unit 33 recognizes the driving area via the information of the GPS data and the map data.

After Step 102 and Step 103, the process proceeds to Step 104. At Step 104, the speed limit recognition unit 40 recognizes the speed limit based on the trailer type and the driving area, which are obtained at Steps 102, 103. After Step 104, the advanced driver assistance system 100 may obtain the speed limit which depends on the combination of the driving area and the trailer type.

After Step 104, when the vehicle 10 is not automated to drive, the advanced driver assistance system 100 executes Step 106 and Step 107. Step 106 and Step 107 compose of driver alert procedure. On the other hand, when the vehicle 10 is automated to drive, the advanced driver assistance system 100 executes Step 108 and Step 109. Step 108 and Step 109 compose of speed control procedure.

At Step 106, the speed comparison unit 51 compares the actual speed with the speed limit. When the actual speed is over the speed limit, Step 107 is executed by the alert unit 61. The alert unit 61 alerts the driver to reduce the actual speed based on the alert signal which is obtained at Step 106. After alerting, the process is ended.

On the other hands, at Step 108, the speed limit control unit 52 restricts the parameter of the control speed so that the control speed is not over the speed limit which is obtained at Step 104. Eventually, the parameter of the control speed is determined by the control speed determination unit 62 so that the control speed is the same as the speed limit which is restricted by the speed limit control unit 52.

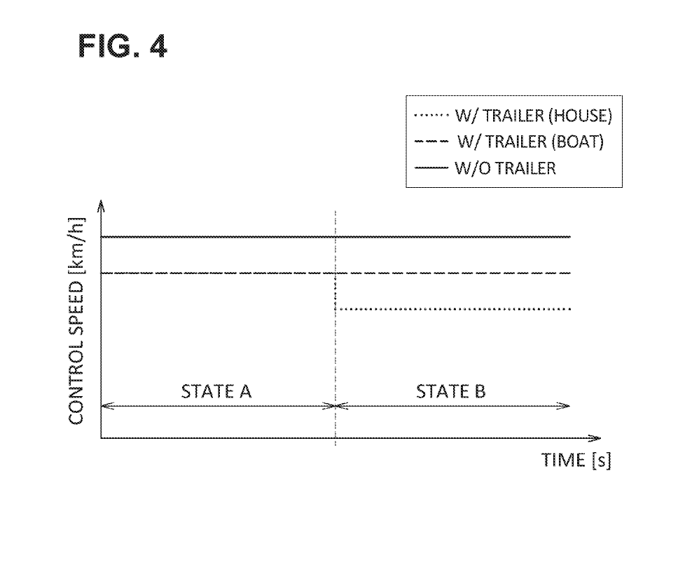

FIG. 4 depicts a graph showing the control speed relative to time according to the present embodiment. FIG. 4 shows the three cases that the vehicle 10 drives from a certain state (hereinafter referred to as State A) to another state (hereinafter referred to as State B). The solid line, which is described in FIG. 4, is the first case of the vehicle 10 towing no trailer. The dashed line, which is described in FIG. 4, is the second case of the vehicle 10 towing the boat-type trailer 20. The dotted line, which is described in FIG. 4, is the third case of the vehicle 10 towing the house-type trailer 20.

When the vehicle 10 is driving in State A, the vehicle 10 towing no trailer is automated to drive at higher control speed than the vehicles 10 towing the trailers 20. The vehicle 10 towing the house-type trailer 20 is automated to drive at the same control speed as the vehicle 10 towing the boat-type trailer 20.

When the vehicle 10 enters in State B, the vehicle 10 towing no trailer is automated to drive at the same control speed as that in State A. Regarding the vehicle 10 towing no trailer, the control speed is not changed since the speed limit of the vehicle 10 towing no trailer in State A is the same as that in State B.

Furthermore, the vehicle 10 towing the boat-type trailer 20 is automated to drive at the same control speed as that in State A. Regarding the vehicle 10 towing the boat-type trailer 20, the control speed is not changed since the speed limit of the vehicle 10 towing the boat-type trailer 20 in State A is the same as that in State B.

However, the vehicle towing the house-type trailer 20 is automated to drive at the different control speed from that in State A. In this example, regarding the vehicle 10 towing the house-type trailer 20, the control speed in State B is lower than that in State A. In that case, the speed limit control unit 52 restricts the parameter of the control speed so that the control speed is not over the speed limit in State B. Eventually, the control speed determination unit 62 determines the parameter of the control speed so that the control speed is the same as the speed limit in State B.

Thus, as shown in FIG. 4, the advanced driver assistance system 100 provides lawful control for the vehicle 10. Especially, the advanced driver assistance system 100 may have the vehicle 10 automated to drive at a lawful speed considering the combination of the trailer type and the driving area.

### Other Embodiments

In the first embodiment, the vehicle 10 towing the house-type trailer 20 is regulated by a lower speed limit than the vehicle 10 towing the boat-type trailer 20. However, the speed limit of the vehicle towing the house-type trailer is not limited to be lower, and may be the same or higher. It should be noted that the speed limit depends on the state.

In the first embodiment, the advanced driver assistance system 100 includes the trailer detecting unit 31. However, the advanced driver assistance system is not limited to own the trailer detecting unit, and may use a common unit to detect whether a vehicle is connected with a trailer. In that case, such a common unit is included in another system, for example, a trailer control system, and so forth.

In the first embodiment, the advanced driver assistance system 100 includes the trailer type detecting unit 32. However, the advanced driver assistance system is not limited to own the trailer type detecting unit, and may use a common unit to detect a type of a trailer which is connected to a vehicle. In that case, such a common unit is included in another system, for example, a trailer control system, and so forth.

In the first embodiment, the advanced driver assistance system 100 includes the driving area recognition unit 33. However, the advanced driver assistance system is not limited to own the driving area recognition unit, and may use a common unit to recognize a driving area where a vehicle is driving. In that case, such a common unit is included in another system, for example, a car navigation system, and so forth.

In the first embodiment, the driving area recognition unit 33 uses the GPS data and the map data to obtain the information of the driving area. However, the information of the driving area is not limited to be recognized by using the GPS data and the map data, and may be recognized by using another data. For example, a driver may register a driving area by hand to a registration interface.

In the first embodiment, the driving area is in the United States of America. However, the driving area is not limited to be in the United States of America, and may be in other countries. In that case, the driving area recognition unit may recognize which country the vehicle is driving in.

In the first embodiment, the control speed determination unit 62 determines the parameter of the control speed to drive the vehicle 10 at the speed limit. However the control speed is not limited to be the same as the speed limit, and may be lower than the speed limit considering safety margins. In the first embodiment, at the same time of Step 102, Step 103 is executed. However the Steps 102, 103 are not limited to be at the same time, and may be in series.

In the first embodiment, the process of the advanced driver assistance system 100 has both of the driver alert procedure at Steps 106, 107 and the speed control procedure at Steps 108, 109. However, the process is not limited to have the both of the procedures, and may have either of the procedures. In that case, the alert unit may alert the driver that the control speed will be changed.

In the first embodiment, at Step 105, when the vehicle 10 is automated to drive, only the speed control procedure is executed. However, the process is not limited to proceed to only the speed control procedure, and may proceed to not only the speed control procedure but also the driver alert procedure.

In the first embodiment, the control speed determination unit 62 is used for the adaptive cruise control. However, the control speed determination unit is not limited to be used for the adaptive cruise control, and may be used for cruise control, autonomous driving, and so forth.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

What is claimed is:

1. An advanced driver assistance system for a vehicle comprising:
a trailer detecting unit detecting whether a trailer is connected with a vehicle;
a trailer type detecting unit detecting a type of the trailer when the trailer detecting unit detects that the trailer is connected with the vehicle, the trailer type detecting unit outputting a trailer type signal;
a driving area recognition unit recognizing a driving area where the vehicle is driving when the trailer detecting unit detects that the trailer is connected with the vehicle, the driving area recognition unit outputting a driving area signal;
a speed limit recognition unit recognizing a regulated speed limit in the driving area based on the trailer type signal and the driving area signal;
a speed comparison unit comparing an actual speed of the vehicle with the speed limit, the speed comparison unit outputting an alert signal when the actual speed is over the speed limit; and
an alert unit alerting a driver, who is driving the vehicle, to reduce the actual speed based on the alert signal.

2. The advanced driver assistance system according to claim 1, wherein
the trailer type detecting unit detects whether the type of the trailer is a boat-type, a house-type, or a car-type.

3. The advanced driver assistance system according to claim 1, wherein
the driving area recognition unit recognizes the driving area via map data and GPS data.

4. The advanced driver assistance system according to claim 1, wherein
the driving area recognition unit recognizes a state as the driving area.

5. The advanced driver assistance system according to claim 1, wherein
the driving area recognition unit recognizes a country as the driving area.

6. The advanced driver assistance system according to claim 1, wherein
the alert unit alerts the driver via a display of a human machine interface.

7. The advanced driver assistance system according to claim 1, wherein
the alert unit alerts the driver via an audio of a human machine interface.

8. The advanced driver assistance system according to claim 1, further comprising:
a speed limit recognition unit recognizing a regulated speed limit in the driving area based on both of the trailer type signal and the driving area signal;
a control speed determination unit determining a parameter of a control speed to have the vehicle driving at the control speed automatically based on the parameter of the control speed; and
a speed limit control unit restricting the parameter of the control speed so that the control speed, which is determined by the control speed determination unit, is not over the speed limit, which is recognized by the speed limit recognition unit.

9. The advanced driver assistance system according to claim 8, wherein
the speed limit control unit restricts the parameter of the control speed so that the control speed is the same as the speed limit.

10. The advanced driver assistance system according to claim 8, wherein
the control speed restrict unit restricts the parameter of the control speed so that the control speed is lower than the speed limit.

11. The advanced driver assistance system according to claim 8, wherein
the control speed determination unit is used for adaptive cruise control.

12. An advanced driver assistance system for a vehicle comprising:
a trailer detecting unit detecting whether a trailer is connected with a vehicle;
a trailer type detecting unit detecting a type of the trailer when the trailer detecting unit detects that the trailer is connected with the vehicle, the trailer type detecting unit outputting a trailer type signal;
a driving area recognition unit recognizing a driving area where the vehicle is driving when the trailer detecting unit detects that the trailer is connected with the vehicle, the driving area recognition unit outputting a driving area signal;
a speed limit recognition unit recognizing a regulated speed limit in the driving area based on the trailer type signal and the driving area signal;
a control speed determination unit determining a parameter of a control speed to have the vehicle driving at the control speed automatically based on the parameter of the control speed; and
a speed limit control unit restricting the parameter of the control speed so that the control speed, which is determined by the control speed determination unit, is not over the speed limit, which is recognized by the speed limit recognition unit.

13. The advanced driver assistance system according to claim 12, wherein
the speed limit control unit restricts the parameter of the control speed so that the control speed is the same as the speed limit.

14. The advanced driver assistance system according to claim 12, wherein
the speed limit control unit restricts the parameter of the control speed so that the control speed is at or lower than the speed limit.

15. The advanced driver assistance system according to claim 12, wherein
the trailer type detecting unit detects whether the type of the trailer is a boat-type, a house-type, a car-type, or other types.

16. The advanced driver assistance system according to claim 12, wherein
the driving area recognition unit recognizes the driving area via map data and GPS data.

17. The advanced driver assistance system according to claim 12, wherein
the driving area recognition unit recognizes a state as the driving area.

18. The advanced driver assistance system according to claim 12, wherein
the driving area recognition unit recognizes a country as the driving area.

19. The advanced driver assistance system according to claim 12, wherein:
the control speed determination unit is used for adaptive cruise control.
